(19) United States
(12) Patent Application Publication
(10) Pub. No.: US 2012/0166958 A1
(43) Pub. Date: Jun. 28, 2012

(54) CONTENT PRESENTATION IN MONITORING SESSIONS FOR INFORMATION TECHNOLOGY SYSTEMS

(75) Inventors: Keith D. Cramer, Pine Island, MN (US); Todd M. Eischeid, Cary, NC (US); Mark E. Molander, Cary, NC (US); Gregory B. Pruett, Raleigh, NC (US)

(73) Assignee: INTERNATIONAL BUSINESS MACHINES CORPORATION, Armonk, NY (US)

(21) Appl. No.: 12/976,915

(22) Filed: Dec. 22, 2010

(51) Int. Cl. G06F 3/048

(52) U.S. Cl. 715/736

(57) ABSTRACT

A computing resource management system maintains a management user interface (UI) on an electronic display screen of an administration console for managing computing resources via a communication link. The management UI comprises plural user interface elements, each user interface element including a physical topography for a managed computing resource and a graphical user interface element corresponding to a session providing information for said managed computing resource. User interaction with a graphical user interface element is monitored. Based on the user interaction, a content element is displayed on the display screen wherein the content element includes information for said corresponding managed computing resource.

### BACKGROUND OF THE INVENTION

1. Field of the Invention

The present invention relates generally to content presentation and in particular to content presentation using graphical user interfaces.

2. Background Information

Management systems are utilized for computer system management such as blade server management. A blade server typically comprises a modular server computer which is disposed in a blade enclosure (chassis) along with other blade servers, wherein the enclosure provides electrical power, cooling, communication management, etc.

Administrators often use management systems to manage servers. This is performed as needed for each server, one at time. The administrators are responsible for managing an increasing numbers of servers. There may also be simultaneous problems on multiple servers. A top goal of an administrator is to identify and address server problems as quickly as possible, requiring a management system that assists in achieving that goal.

### BRIEF SUMMARY OF THE INVENTION

Embodiments of the invention provide computing resource management utilizing user interfaces. One embodiment comprises a computing resource management system that maintains a management user interface (UI) on an electronic display screen of an administration console for managing computing resources via a communication link. The management UI comprises plural user interface elements, each user interface element including a physical topography for a managed computing resource and a graphical user interface element corresponding to a session providing information for said managed computing resource. User interaction with a graphical user interface element is monitored. Based on the user interaction, a content element is displayed on the display screen wherein the content element includes information for said corresponding managed computing resource.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1A illustrates a system for content presentation, according to one embodiment of the invention;

FIG. 1B illustrates a system for content presentation, according to one embodiment of the invention;

FIG. 2A illustrates a session window including GUI elements for managing multiple server systems using content presentation, according to one embodiment of the invention;

FIG. 2B illustrates a session window with an enlarged GUI element as a property/type window based on user input, according to one embodiment of the invention;

FIG. 2C illustrates a session window with an enlarged GUI element as a popup window based on user input, according to one embodiment of the invention;

FIG. 2D illustrates a session window with an enlarged GUI element as a tabbed window/panel based on user input, according to one embodiment of the invention;

FIG. 2E illustrates a session window with an enlarged GUI element as an on-demand user interface based on user input, according to one embodiment of the invention;

FIG. 3 illustrates a process flowchart for content presentation, according to one embodiment of the invention; and

FIG. 4 illustrates a high level block diagram of an information processing system useful for implementing one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification, as well as meanings understood by those skilled in the art and/or as defined in dictionaries, treatises, etc. The description may disclose several preferred embodiments for content presentation, as well as operation and/or component parts thereof. While the following description will be described in terms of content presentation systems and processes for clarity and placing the invention in context, it should be kept in mind that the teachings herein may have broad application to all types of systems, devices and applications.

Embodiments of the invention provide a computing resource management system that generates a management UI that displays a physical topology for computing resources, on an electronic display for managing the computing resources (e.g., monitoring and/or controlling) by operators. The management UI further includes status and/or control information. The physical topology (e.g., chassis map UI) of the computing resources displayed in the management UI is analogous to the actual hardware layout of the computing resources (e.g., blade servers), wherein UI elements such as thumbnails are embedded within the physical topology.

In one embodiment, the management UI comprises a physical topology user interface, including session thumbnails embedded in the hardware physical topology, allowing a user (operator) of the user interface to view desired information about monitored computer system resources such as blade servers. In one embodiment, the invention provides live thumbnail sessions for systems within a physical topology representation of the systems. The thumbnails are launched on a larger remote session view. Embodiments of the invention integrate two UI models providing intuitive physical topology views of resources, and live thumbnails for a system operator (administrator).

An embodiment of the invention is described below in relation to a control session. The control session comprises a management UI comprising a graphical user interface implemented on an administration console for monitoring and controlling server systems such as blade servers in information technology systems. The control session may be a remote control session or a local control session in relation to the server systems.

Such a graphical user interface includes graphical elements that represent the physical topology of components of the server systems being remotely controlled. An administration console can be used to remotely/locally control multiple server systems, or multiple components of a server system. In one example, an administration console comprises a client computer system for monitoring a server system comprising one or more servers such as blade servers.

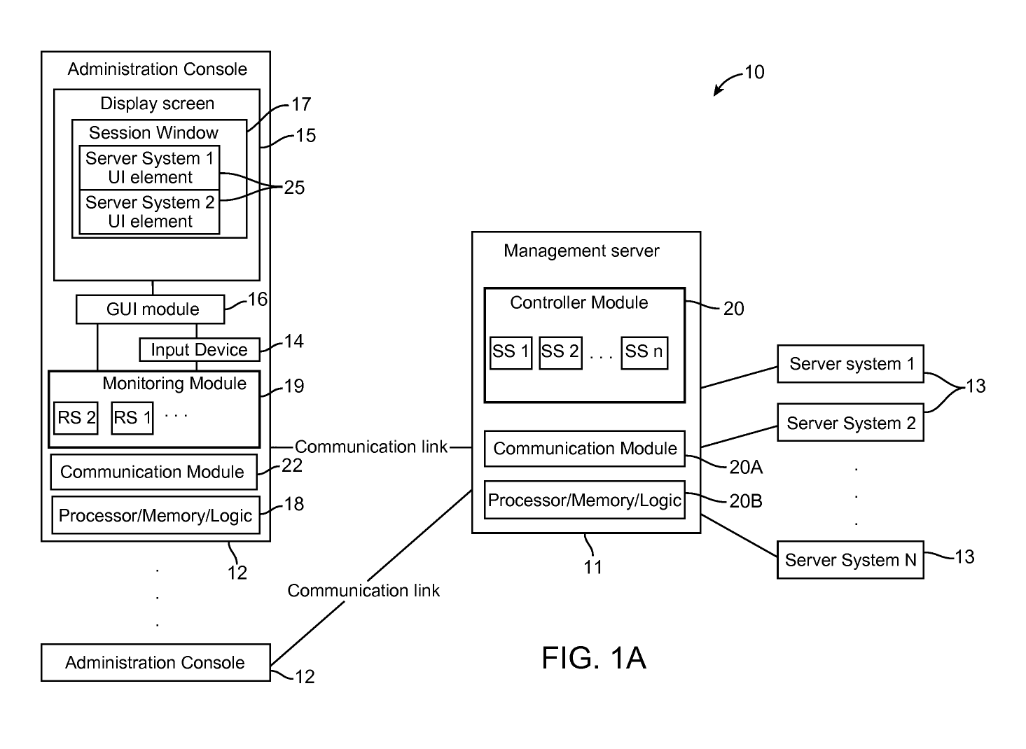

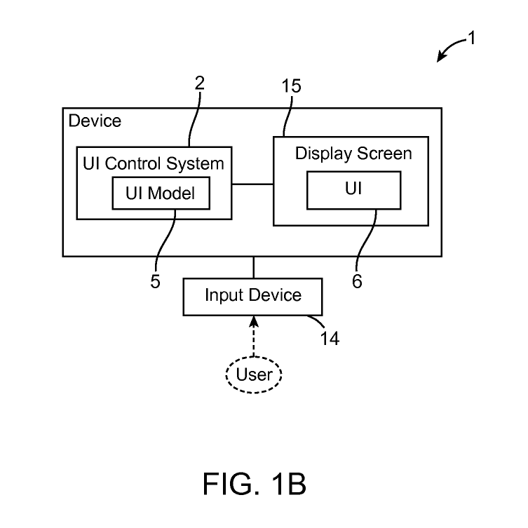

FIG. 1A shows a block diagram of an information technology system 10 according to an embodiment of the invention. The system 10 comprises a management server 11 and one or more administration consoles 12, wherein the management server 11 is configured for connection to each administration console 12 via a communication link. The management server 11 is connected to multiple server systems 13 to be monitored (monitoring a server system may also include controlling the server system).

In one embodiment, an administration console 12 includes an input device 14, an electronic display screen 15, a GUI module 16 configured for controlling display of content elements including GUI elements such as windows on the display screen 15, a communication module 22 (such as a network interface module) configured for information communication over a communication link (e.g., network, channel, wireless link), a processing module 18 including processor, memory and logic, and a monitoring module 19 configured for managing at least one session RS on the administration console 12 for monitoring one or more server systems 13 via the management server 11.

Users (operators) such as IT administrators utilize the sessions RS in the administration consoles 12 for monitoring server systems 13 via the management server 11. A controller module 20 in the management server 11 enables processing and communication between the administration consoles 12 and the management server 11, thereby enabling a number of active sessions RS at each administration console 12.

According to an embodiment of the invention, at each administration console 12, a user may utilize the input device 14 (e.g., a pointer such as a mouse or touch screen) to manipulate GUI elements on the display screen 15 as controlled by a GUI module 16. Such manipulation includes establishing a RS session in a session window 17 as an active session, bringing a session window into active focus, taking a session window out of focus, moving session windows, hiding session windows, partially blocking a session window with other GUI elements, etc.

According to an embodiment of the invention, at each remote administration console 12, the monitoring module 19 maintains a session RS for each server system 13 that is monitored by that remote administration console 12. As such, there is a session RS for each monitored server system 13. Each session RS has a corresponding UI element 25 in a session window 17 that is associated with the corresponding monitored server system 13, wherein the session window 17 displays information about the monitored server systems 13 on the display screen 15.

In one embodiment of the invention, said monitoring module 19 determines (monitors) display status of the session window 17 on the display screen 15 and monitors user interaction with each UI element 25. Determining display status of the session window 17 comprises, for example, user interaction with the GUI elements 25 (such as clicking on a UI element 25). In one embodiment, the monitoring module 19 communicates that information to the controller module 20 of the management server 11. The management server further includes a communication module 20A and hardware 20B. The management UI session window 17 displays information including information about managed computing resources that are made accessible to the remote consoles 12 via the controller module 20 of the management server 11 (and additional management servers 11 as may be needed).

Referring to FIG. 1B, the GUI module and the monitoring module form a UI control system 2 for an information technology system 1. The UI control system 2 provides content presentation in a user interface 6 (such as the window 17 in FIG. 1A) on an electronic display screen/monitor 15. The user interface 6 includes GUI elements (such as GUI elements 25 in FIG. 1A). The UI control system 2 controls the user interface 6 and the GUI elements therein, based on user input (input event) via the input device 14.

In one embodiment, the UI control system 2 includes a UI model 5 including factors which dictate system response based on user interaction with the GUI elements and based on other factors such as status of servers being monitored. In one embodiment, the UI model 5 may comprise a look-up table or programming of factors which dictate system response based on user interaction with a GUI element for each of a number of factors (e.g., user input such as pointer motion, pointer location, pointer hover, mouse-over), as described further below. The factors of the UI model 5 may be updated/modified as desired for various desired behaviors.

In one embodiment, when a user interacts with a UI element 25 by providing input using an input device such as a mouse pointer, the system displays a content element for the UI element 25 (e.g., popup window, tabbed window, on-demand user interface, etc.) on the display screen.

Referring to FIG. 1A, the controller module 20 maintains a server session SS for each connected server system 13 monitored. Each server session SS at the management server 11 for an associated server system 13 being monitored, is associated with a corresponding session RS at a administration console 12. In one embodiment of the invention, a server session SS comprises a module providing a session management process for maintaining status/control information for the corresponding server system 13. In one embodiment, a session RS comprises a module providing a session management process for keeping track of user activity and interaction with the administration console (such as with a GUI element associated with a corresponding session RS).

In another embodiment of the invention, a server system 13 may have one or more dynamic sessions at an administration console 12 (e.g., a remote session with an operating system, one or more remote sessions with the virtual machines, a hardware-level out-of-band remote session with the system, and a remote session with the service processor of the system). In that case, such a server system 13 has multiple GUI elements 25, and corresponding RS sessions and SS sessions. Other examples of sessions include Command Line Interface (CLI) or serial sessions, or a session with a base management controller of a blade server (e.g., Integrated Management Module or Flexible Service Processor).

In one embodiment of the invention, the monitoring module 19 at the administration console 12 is configured to refresh one or more GUI elements 25 in the session window 17 with full/partial refresh information from the management server 11. One or more GUI elements 25 may be less frequently refreshed, or refreshed with less information (e.g., with lower color depth and resolution).

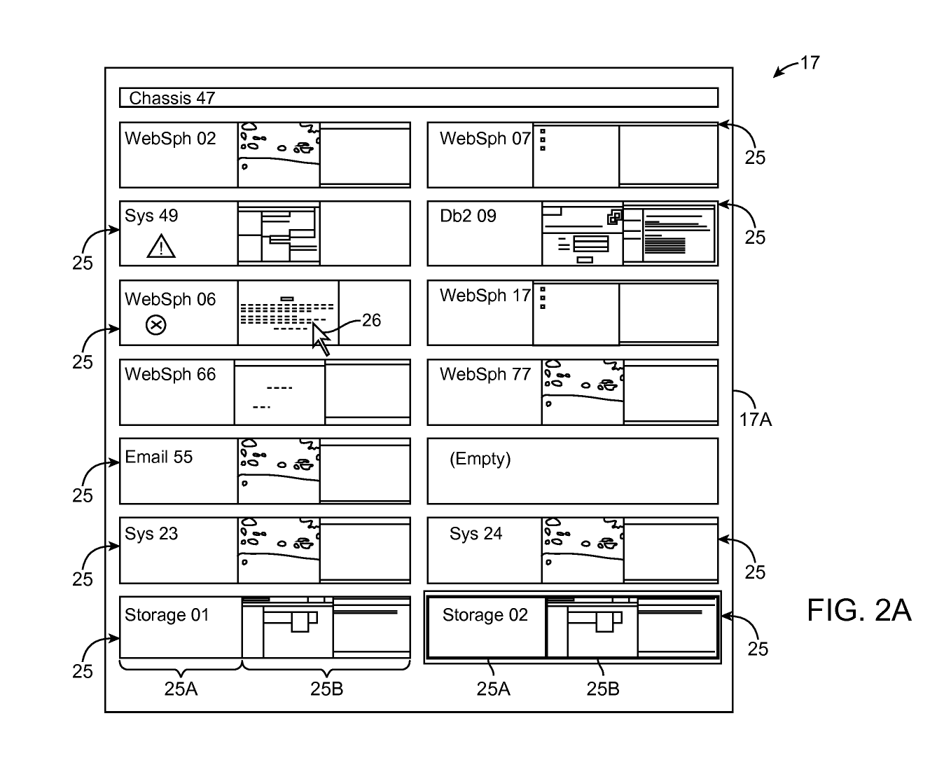

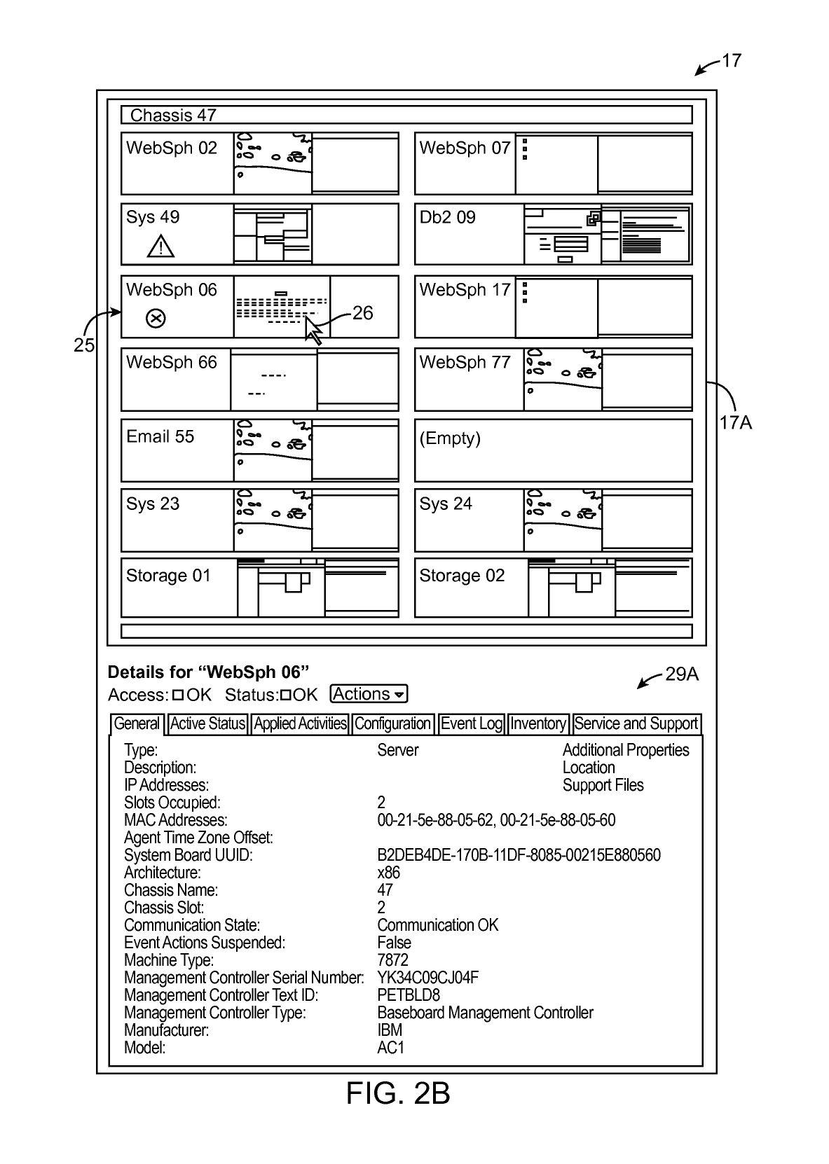

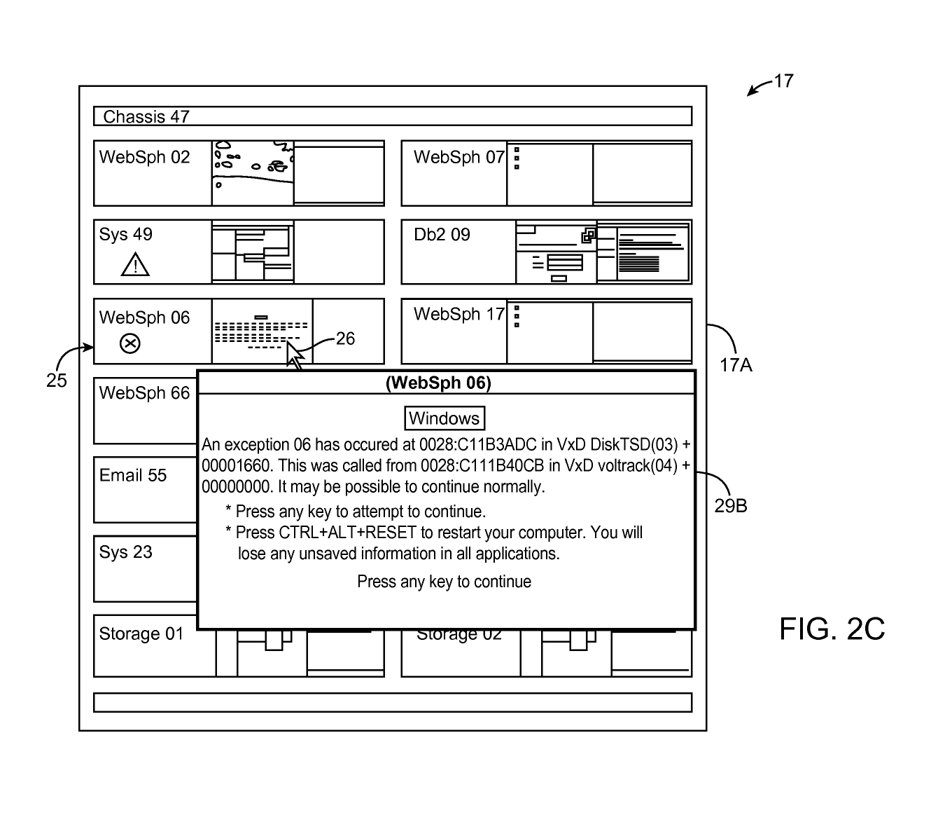

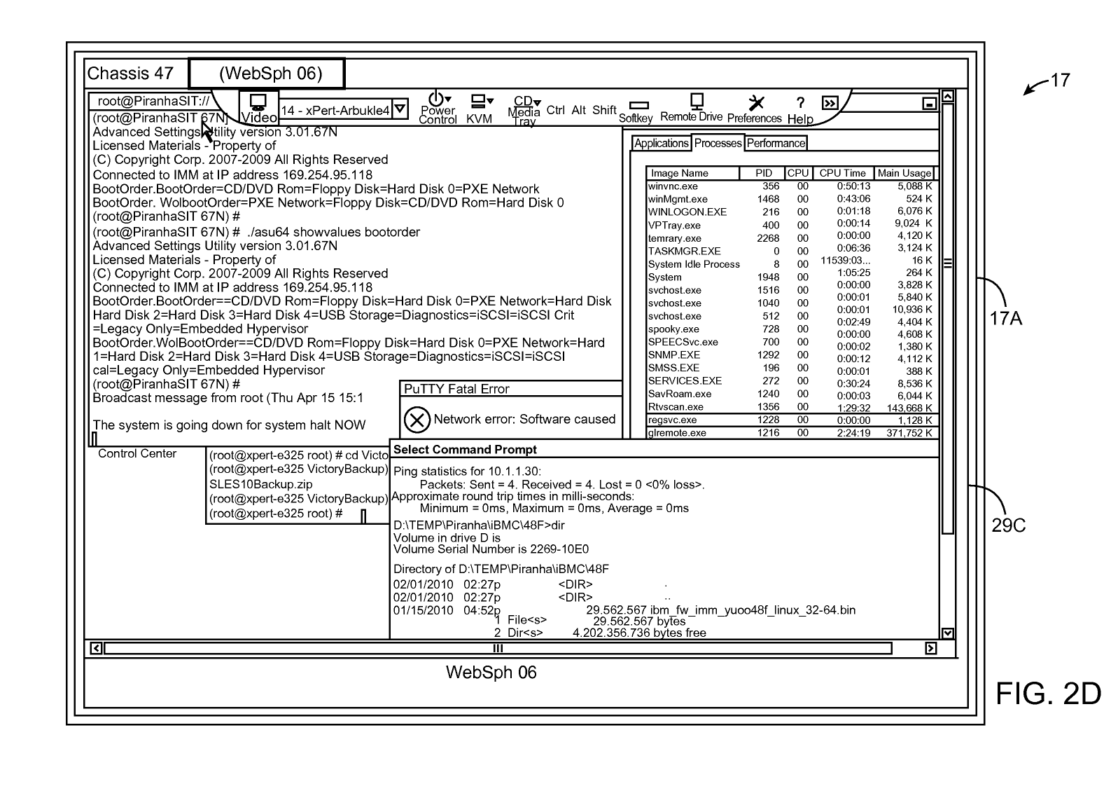

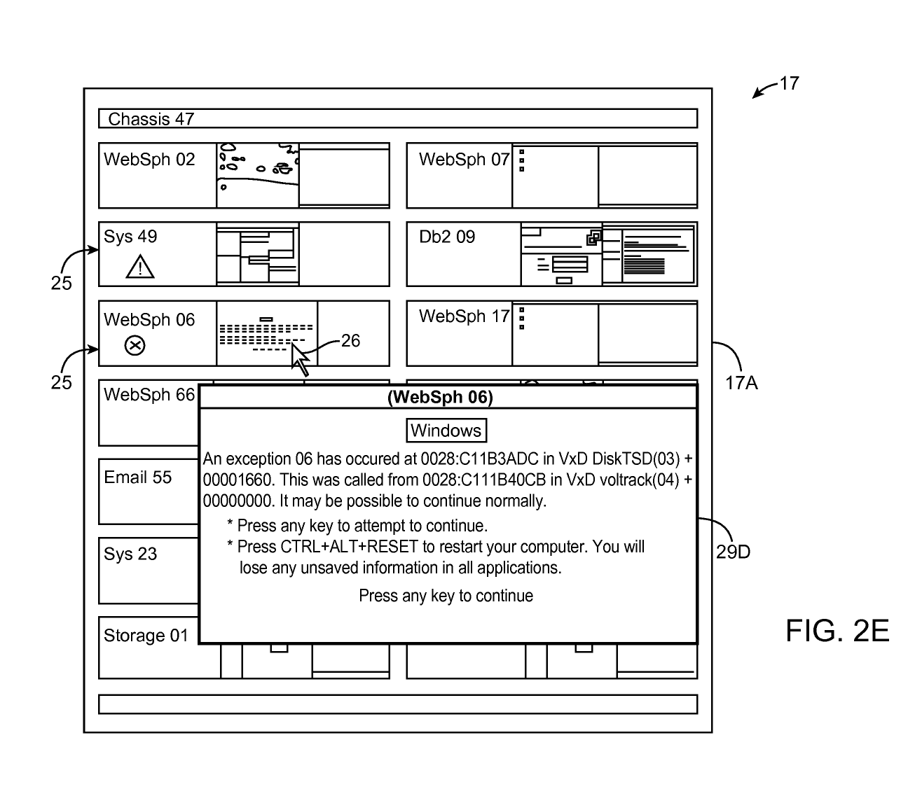

FIG. 2A shows an example session window 17 including multiple UI elements 25. The session window 17 may include other UI elements (such as thumbnails for other applications), not shown. An IT administrator may keep many sessions open (running) on the session window 17 of an administration console 12, as shown by example in FIG. 2A.

In one embodiment of the invention, each UI element 25 comprises a graphical physical topology 25A and a GUI element 25B including status/control information, for a corresponding server system 13. In one embodiment, each GUI element 25B comprises a session thumbnail 25B embedded with the physical topology representation 25A for a server system 13. The session thumbnail 25B provides information for that server system 13, as described further below. A thumbnail is a reduced version of a window in a GUI, wherein the thumbnail occupies a smaller area of the display screen than the windows itself and typically displays a subset of the information of the window.

Specifically, the session window 17 in FIG. 2A illustrates UI elements 25, each UI element including a physical topology GUI element 25A and a session thumbnails 25B for a managed computing resource (e.g., blade server), integrated into a physical topology session window UI 17. The UI elements 25 represent physical topology (chassis map) of computing resources in a chassis (e.g., chassis 47), which in this example are arranged as two columns of seven rows of UI elements 25. The user utilizes the input device 14 to interact with the session window 17 (via the GUI module 16 and the monitoring module 19).

In one example user interaction according to the invention, to enlarge and work with a particular thumbnail 25B, the user may click on a thumbnail 25B of a session (e.g., a remote session) using a pointer 26, to display information for the remote session of a corresponding server system 13 in a content element such a dedicated Details/Property-like area (window) 29A adjacent to a chassis map 17A, as shown by example in FIG. 2B. In one embodiment, the information in the thumbnail 25B and the information in the content element 29A comprises a console (e.g., output screen, input screen) for monitoring and/or controlling a server system 13. In one example, a console window 29A allows a user to remotely interact with the server 13 as though the user is at the server 13 and interacting directly with the server 13.

In another example user interaction according to the invention, to enlarge and work with a particular GUI element thumbnail 25B, the user may click on a thumbnail 25B of a session (e.g., a remote session) using a pointer 26, to launch the session into a content element comprising new popup window 29B that displays information for the remote session of a corresponding server system 13, as shown by example in FIG. 2C.

In another example user interaction according to the invention, to enlarge and work with a particular GUI element thumbnail 25B, the user may click on a thumbnail 25B of a session (e.g., a remote session) using a pointer 26, to launch the session into a content element comprising new tabbed panel 29C (e.g., overlaying the chassis map panel), that displays the remote session of a corresponding server system 13, as shown by example in FIG. 2D.

In another example user interaction according to the invention, to enlarge and work with a particular GUI element thumbnail 25B, the user may mouse-over a thumbnail 25B of a session (e.g., a remote session) using a pointer 26 for a long-enough hovering delay, to launch the session into a content element comprising an on-demand user interface 29D (e.g., dismissible popup window), that displays a larger remote session view for a corresponding server system 13, as shown by example in FIG. 2E. The window 29D disappears when the user moves the pointer 26 off the thumbnail (i.e., the pointer 26 is no longer hovering over a thumbnail 25).

In the above examples, the type of content element can be selected by the user or be programmed in based on the type of input from the user, wherein each type of input provides a different content element (e.g., mouse right click provides content element 29A, mouse left click provides content element 29B, double click provides content element 29C, mouse-over, provides content element 29D, etc.)

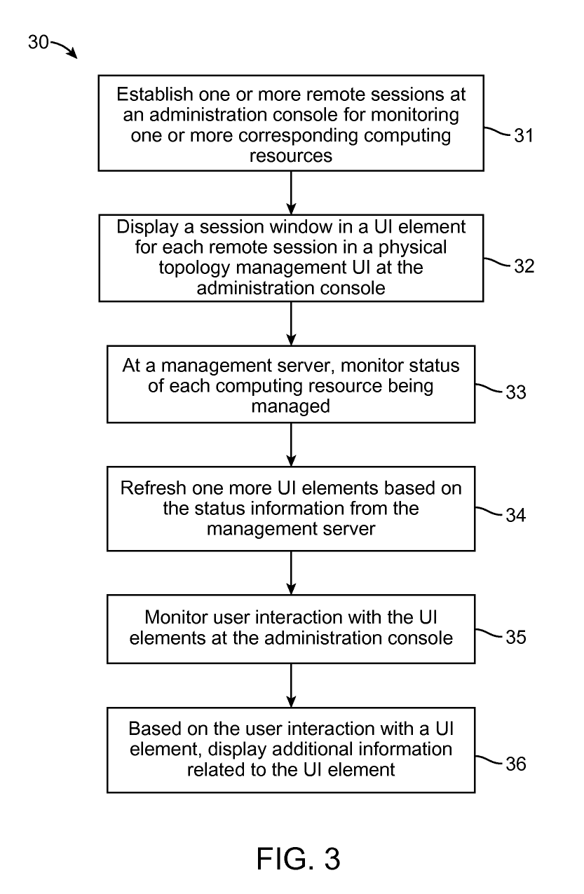

FIG. 3 shows a flowchart of a process 30 for, according to an embodiment of the invention, comprising the following process blocks:
Block 31: Establish one or more sessions at an administration console for monitoring one or more corresponding computing resources such as server systems.
Block 32: Display a session window for each remote session in a physical topology management UI at the administration console, wherein the session window includes multiple UI elements corresponding to the sessions for managing said server systems (a UI element comprises a physical topology and a session thumbnail 25B, for a managed computing resource).
Block 33: At a management server, determine status of each computing resource being managed.
Block 34: Refresh one more UI elements based on the status information from the management server.
Block 35: Monitor user interaction with the UI elements at the administration console.
Block 36: Based on the user interaction with a UI element, display additional information related to the UI element (e.g., popup window, tabbed panel, etc.) for the corresponding managed resource, as described above.

In one example, block 34 involves selectively obtaining and/or displaying information (e.g., server system status) from the management server 11 to the administration console 12 over the communication link for one or more UI elements 25 (e.g., thumbnail 25B) needing refresh. The quantity of refresh information requested/received for each monitored server system can be a function of the display status (e.g., visible portion, thumbnail, window) of the session at the administration console for the monitored server system.

In one embodiment of the invention, an optional “chassis map” view filter is provided by the monitoring module and the GUI module to turn on one or more sessions for each server 13. In one example, this allows the user additional visual clues and immediate access to the sessions the user may need for managing a problem server. In another example, this allows the user to perform common maintenance tasks (such as firmware or operating system patches), wherein the user visually monitors the progress of multiple servers at the same time using the thumbnails 25, and also has access to all the thumbnails 25 at the same time.

Embodiments of the invention are also useful with other collections of servers, such as rack-optimized servers, and for other data center equipment such as storage and networking devices.

Embodiments of the invention can take the form of a computer simulation or program product accessible from a computer-usable or computer-readable medium providing program code for use by or in connection with a computer, processing device, or any instruction execution system. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing. Computer program code for carrying out operations for aspects of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

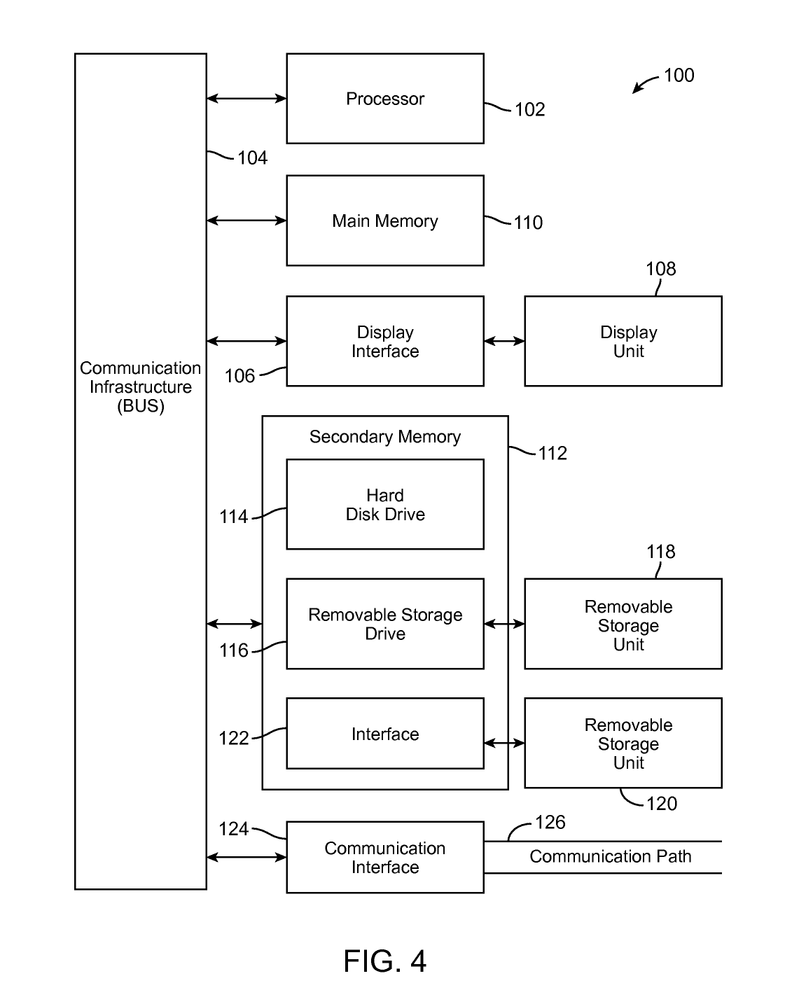

FIG. 4 is a high level block diagram showing an information processing system 100 useful for implementing one embodiment of the present invention. The computer system 100 includes one or more processors, such as one or more processors 102. The processor 102 is connected to a communication infrastructure 104 (e.g., a communications bus, cross-over bar, or network).

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc., which is read by and written to by removable storage drive 116. As will be appreciated by those skilled in the art, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communication channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via a communication interface 124. Such computer programs, when run, enable the computer system to perform the features of the present invention as discussed herein. In particular, the computer programs, when run, enable the processor 102 to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method of computing resource management, comprising:
maintaining a management user interface (UI) on an electronic display screen of an administration console for managing computing resources via a communication link, the management UI comprising plural user interface elements, each user interface element including a physical topography for a managed computing resource and a graphical user interface element corresponding to a session providing information for said managed computing resource;
monitoring user interaction with a graphical user interface element based on user input; and
based on the user interaction, displaying a content element on the display screen wherein the content element includes information for managing said corresponding managed computing resource.

2. The method of claim of claim 1, wherein:
a computing resource includes a server resource;
displaying a content element comprises: displaying the content element at a location on the display screen in response to an input event over a graphical user interface element based on user input.

3. The method of claim 2, wherein the content element comprises a popup window console for managing the server resource.

4. The method of claim 2, wherein the content element comprises a tabbed window console for managing the server resource.

5. The method of claim 2, wherein the content element comprises an on-demand content element displayed after a delay period while a pointer hovers over a graphical user interface element.

6. The method of claim 2, wherein displaying a content element comprises:
launching a session in the content element for display on the display screen, wherein the session provides a console for managing the corresponding server resource.

7. The method of claim 2, further comprising:
selectively transmitting a quantity of refresh information for a user interface element from a management server to the administration console for display in the user interface element, wherein the refresh information comprises status information for said monitored server resource.

8. The method of claim 2, further comprising:
selectively transmitting a quantity of refresh information for a content element from a management server to the administration console for display in the user interface element, wherein the refresh information comprises status information for said monitored server resource.

9. A computer program product comprising:
a computer usable medium having computer readable program code embodied therewith for execution on a computer, the computer readable program code configured to:
maintain a management user interface (UI) on an electronic display screen of an administration console for managing computing resources via a communication link, the management UI comprising plural user interface elements, each user interface element including a physical topography for a managed computing resource and a graphical user interface element corresponding to a session providing information for said managed computing resource;
monitor user interaction with a graphical user interface element based on user input; and
based on the user interaction, display a content element on the display screen wherein the content element includes status information for managing said managed computing resource.

10. The computer program product of claim 9, wherein:
a computing resource includes a server resource; and
the computer readable program code is configured to: display the content element at a location on the display screen in response to an input event over a graphical user interface element based on user input.

11. The computer program product of claim 10, wherein the content element comprises a popup window console for managing the server resource.

12. The computer program product of claim 10, wherein the content element comprises a tabbed window console for managing the server resource.

13. The computer program product of claim 10, wherein:
the content element comprises an on-demand content element displayed after a delay period while a pointer hovers over a graphical user interface element.

14. The computer program product of claim 10, wherein the computer readable program code is configured to:
display a content element by launching a session in the content element for display on the display screen, wherein the session provides a console for managing the corresponding server resource.

15. The computer program product of claim 9, wherein the computer readable program code is configured to:
selectively transmit a quantity of refresh information for a user interface element from a management server to the administration console for display in the user interface element, wherein the refresh information comprises status information for said monitored server resource.

16. The computer program product of claim 9, wherein the computer readable program code is configured to:
selectively transmit a quantity of refresh information for a content element from a management server to the administration console for display in the user interface element, wherein the refresh information comprises status information for said monitored server resource.

17. A system for content presentation on an electronic display, comprising:
a user interface module configured for maintaining a management user interface (UI) on an electronic display screen of an administration console for managing computing resources via a communication link, the management UI comprising plural user interface elements, each user interface element including a physical topography for a managed computing resource and a graphical user interface element corresponding to a session providing information for said managed computing resource; and
a monitoring module configured for monitoring user interaction with a graphical user interface element based on user input, and based on the user interaction, displaying a content element on the display screen wherein the content element includes information for managing said corresponding managed computing resource.

18. The system of claim 17, wherein:
a computing resource includes a server resource; and
the monitoring module causes display of the content element at a location on the display screen in response to an input event over a graphical user interface element based on user input.

19. The system of claim 18, wherein the content element comprises one or more of: a popup window, a tabbed window, and an on-demand content element displayed after a delay period while a pointer hovers over a graphical user interface element, console for managing the server resource.

20. The system of claim 18 further comprising:
a management server configured for selectively transmitting a quantity of refresh information for a user interface element to the administration console for display in the user interface element, wherein the refresh information comprises status information for said monitored server resource; and
the management server further configured for selectively transmitting a quantity of refresh information for a content element to the administration console for display in the user interface element, wherein the refresh information comprises status information for said monitored server resource.
